(19) United States
(12) Patent Application Publication
(10) Pub. No.: US 2026/0266642 A1
(43) Pub. Date: Sep. 10, 2026

(54) FLOW CONDITIONING DEVICE CONFIGURED FOR IMPLEMENTATION WITH A FLOW SENSOR IN COMPONENTS OF DISPENSING SYSTEMS AND DISPENSING SYSTEMS AND PROCESSES IMPLEMENTING THE SAME

(71) Applicant: NORDSON CORPORATION, WESTLAKE, OH (US)

(72) Inventors: Sven RÖHRING, Lüneburg/Lower Saxony (DE); Helge LIPPELT, Lüneburg/Lower Saxony (DE); Lutz MÜLLER, Südergellersen/Lower Saxony (DE)

(73) Assignee: NORDSON CORPORATION, WESTLAKE, OH (US)

(21) Appl. No.: 19/167,904

(22) PCT Filed: Mar. 27, 2024
(86) PCT No.: PCT/US2024/021604

§ 371 Date: Sep. 23, 2025

Related U.S. Application Data
(60) Provisional application No. 63/492,669, filed on Mar. 28, 2023.

(51) Int. Cl. G01F 1/684; B05C 11/10; G05B 6/02

(52) U.S. Cl. CPC G01F 1/6842; B05C 11/10; G05B 6/02

(57) ABSTRACT

A sensing device includes a flow conditioning device configured to receive a dispensing material and the flow conditioning device is further configured mix the dispensing material and equalize a thermal profile of the dispensing material; a sensor channel configured to receive the dispensing material from the flow conditioning device; and a sensor unit configured to measure a temperature of the dispensing material in the sensor channel.

### CROSS-REFERENCE TO RELATED APPLICATIONS

This application is a National Stage Application of International Patent App. No. PCT/US 2024/021604, filed Mar. 27, 2024, which claims the benefit of U.S.

Provisional Patent App. No. 63/492,669, filed Mar. 28, 2023, the entire disclosures of both of which are hereby incorporated by reference as if set forth in their entirety herein.

### FIELD OF THE DISCLOSURE

The disclosure relates to a flow conditioning device configured for implementation with a flow sensor for mass flow measurement in components of dispensing systems. The disclosure further relates to dispensing systems implementing a flow conditioning device configured for implementation with a flow sensor for mass flow measurement. The disclosure relates to processes for implementing a flow conditioning device configured for implementation with a flow sensor for mass flow measurement in components of dispensing systems.

### BACKGROUND OF THE DISCLOSURE

Dispensing systems that dispense flowable material, such as hot melt adhesive, are widely used in the manufacturing and packaging industries. For example, hot melt adhesive may be used for carton sealing, case sealing, tray forming, pallet stabilization, non-woven applications, among others. Dispensing systems can typically implement a sensor unit for measuring a mass flow rate in the flowable material. Such a sensor unit typically uses the principle of convection anemometry and requires no direct interference with the mass flow of the flowable material by moving mechanical parts. The measuring principle requires the heating of a temperature measurement device beyond the temperature of the flowable material. The temperature of the flowable material is determined by means of a further temperature measurement device. Depending on the flow rate of the flowable material surrounding the heated temperature measurement device, a larger or lesser amount of heat is released to the fluid flowing around. However, variations in the temperature of the flowable material in proximity to the sensor unit can cause a decrease of flow data accuracy.

Accordingly, there exists a need for a device and process for reducing variations in the temperature of the flowable material in proximity to a sensor unit to increase flow data accuracy.

### SUMMARY OF THE DISCLOSURE

The foregoing needs are met, to a great extent, by the disclosure, wherein in one aspect a device and/or a process are provided for reducing variations in the temperature of the flowable material in proximity to the sensor unit to increase flow data accuracy.

In one general aspect, a sensing device includes a flow conditioning device configured to receive a dispensing material and the flow conditioning device is further configured mix the dispensing material and equalize a thermal profile of the dispensing material. The sensing device in addition includes a sensor channel configured to receive the dispensing material from the flow conditioning device. The sensing device moreover includes a sensor unit configured to measure a temperature of the dispensing material in the sensor channel.

In one general aspect, a process includes configuring a flow conditioning device to receive a dispensing material. The process in addition includes mixing the dispensing material and equalizing a thermal profile of the dispensing material with the flow conditioning device. The process moreover includes receiving the dispensing material from the flow conditioning device in a sensor channel. The process also includes measuring a temperature of the dispensing material in the sensor channel with a sensor unit.

There has thus been outlined, rather broadly, certain aspects of the disclosure in order that the detailed description thereof herein may be better understood, and in order that the present contribution to the art may be better appreciated. There are, of course, additional aspects of the disclosure that will be described below and which will form the subject matter of the claims appended hereto.

In this respect, before explaining at least one aspect of the disclosure in detail, it is to be understood that the disclosure is not limited in its application to the details of construction and to the arrangements of the components set forth in the following description or illustrated in the drawings. The disclosure is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the disclosure. It is important, therefore, that the claims be regarded as including such equivalent constructions insofar as they do not depart from the spirit and scope of the disclosure.

### BRIEF DESCRIPTION OF THE DRAWINGS

FIG. 1 schematically illustrates a flow conditioning device implemented with a sensor unit according to aspects of the disclosure.

FIG. 2 schematically illustrates the flow conditioning device implemented in a system according to aspects of the disclosure.

FIG. 3 schematically illustrates the flow conditioning device implemented in a system according to aspects of the disclosure.

FIG. 4 illustrates a side view of an exemplary implementation of the flow conditioning device and the dispensing device according to aspects of the disclosure.

FIG. 5 illustrates a perspective view of the exemplary implementation of the flow conditioning device, the sensor unit, and the dispensing device according to FIG. 4.

FIG. 6 illustrates a perspective view of the exemplary implementation of the flow conditioning device, the sensor unit, and the dispensing device according to FIG. 4.

FIG. 7 illustrates a partial side view in partial transparent side view of an exemplary implementation of the flow conditioning device and the static mixer adapter unit according to aspects of the disclosure.

FIG. 8 illustrates a partial perspective view and partial transparent perspective view of an exemplary implementation of the flow conditioning device and the static mixer adapter unit according to FIG. 7.

FIG. 9 schematically illustrates the flow conditioning device implemented in a system according to aspects of the disclosure.

FIG. 10 illustrates a partial side view in partial transparent side view of an exemplary implementation of the flow conditioning device and the hose adapter unit according to aspects of the disclosure.

FIG. 11 illustrates a partial perspective view and partial transparent perspective view of an exemplary implementation of the flow conditioning device and the hose adapter unit according to FIG. 10.

FIG. 12 schematically illustrates the flow conditioning device implemented in a system according to aspects of the disclosure.

FIG. 13 illustrates a partial side view and a partial transparent side view of an exemplary implementation of the flow conditioning device and the material transport device according to aspects of the disclosure.

FIG. 14 illustrates a side view of an exemplary implementation of the flow conditioning device, the material transport device, and the dispensing device according to aspects of the disclosure.

FIG. 15 illustrates a perspective view of the exemplary implementation of the flow conditioning device, the sensor unit, the material transport device, and the dispensing device according to FIG. 14.

FIG. 16A and FIG. 16B illustrate flow and thermal profiles of the dispensing material within the flow channel as the dispensing material is homogenized by the flow conditioning device with the aspects of the disclosure.

FIG. 17 illustrates a flow and thermal profile of the dispensing material within the sensor channel according to aspects of the disclosure.

FIG. 18 illustrates a graph of an actual flow rate and measured flow rate versus time for implementation without the flow conditioning device according to aspects of the disclosure; and FIG. 18 further illustrates a graph of an actual flow rate and a measured flow rate versus time for implementation with the flow conditioning device according to aspects of the disclosure.

FIG. 19 illustrates an exemplary controller according to aspects of the disclosure.

FIG. 20 illustrates a process of determining a temperature and/or a mass flow rate of a dispensing material according to aspects of the disclosure.

### DETAILED DESCRIPTION

The disclosure will now be described with reference to the drawing figures, in which like reference numerals refer to like parts throughout. Aspects of the disclosure advantageously provide a device and/or a process for reducing variations in the temperature of the flowable material in proximity to the sensor unit to increase flow data accuracy.

Based on using the convection anemometry measurement principles, variations in a temperature measurement of a flowable material and a temperature measurement of a heating sensor can cause a decrease of flow data accuracy. In particular, temperature differences of a laminar flowable material flow in a flow channel influence a mass flow measurement negatively.

In aspects of the disclosure, by using a flow conditioning device, such as static mixer, it is possible to have a homogenous adhesive flow in the flow channel to increase flow data accuracy.

In aspects of the disclosure, a static mixer adapter unit, which may be heated or not heated, may be implemented. The compact convection anemometry mass flow sensor may be placed in an applicator, such as a hotmelt applicator, for direct sensing of the adhesive flow at the application point to increase flow data accuracy.

In particular aspects, the static mixer adapter unit may be placed between the hotmelt applicator and the hotmelt hose. More specifically, at one side the molten adhesive flows from the hotmelt hose into the adapter unit. The molten adhesive passes the static mixer. The static mixer causes a homogenous laminar adhesive flow in the flow channel. Then, the molten adhesive passes the compact convection anemometry flow sensor integrated into the hotmelt applicator to measure the mass flow. A hose connecter on the other side is connected with the applicator and is the outlet of the molten adhesive in the static mixer adapter unit. The static mixer adapter unit may be unheated or heated to avoid being a cold spot in the hotmelt adhesive flow system.

In aspects of the disclosure, a hose connection adapter unit with an integrated mixer may be implemented in conjunction with a compact convection anemometry flow sensor. The compact convection anemometry mass flow sensor may be placed near the hotmelt applicator for direct sensing of the adhesive flow near at the application point to increase flow data accuracy. In particular aspects, the static mixer adapter unit be placed between the hotmelt applicator and the hotmelt hose. More specifically, at one side the molten adhesive flows from the hotmelt hose into the adapter unit. The molten adhesive passes the static mixer. The static mixer causes a homogenous laminar adhesive flow in the flow channel. Then, the molten adhesive passes the compact convection anemometry flow sensor integrated into the hotmelt applicator to measure the mass flow. A hose connecter on the other side may be connected with the applicator and is the outlet of the molten adhesive in the static mixer adapter unit. In aspects, the static mixer adapter unit may be unheated or heated to avoid being a cold spot in the hotmelt adhesive flow system.

In aspects of the disclosure, a “Uni Flow” heated hotmelt hose with an integrated static mixer may be implemented. In aspects, the compact convection anemometry mass flow sensor may be placed in the hotmelt applicator for direct sensing of the adhesive flow at the application point to increase flow data accuracy. In further aspects, the molten adhesive flows from melter pump or pump station through the “Uni Flow” hotmelt hose into the hotmelt applicator. The molten adhesive passes the static mixer integrated in the “Uni Flow” hotmelt hose. The static mixer causes a homogenous laminar adhesive flow in the flow channel. Then, the molten adhesive passes the compact convection anemometry flow sensor integrated into the hotmelt applicator to measure the mass flow. In aspects, the static mixer integrated in the hose is unheated or heated to avoid being negative influence as cold spot in the hotmelt adhesive flow system.

In these aspects, a convection anemometry principle with constant-temperature algorithm (CTA: Constant Temperature Anemometer) may use heat transfer to determine flow speed. In aspects, as molten adhesive passes across sensor plates of the sensor unit, heat is carried from a heated sensor plate to the hotmelt material. The amount of heat that is transferred follows the material flow increase or decrease. By knowing the heat transfer, the mass flow rate can be determined and calculated from the amount of electrical energy compensation needed to maintain a constant temperature differential in a closed-loop control system. The heater and sensor feedback signals may be controlled by a closed-loop system with PID (proportional-integral-derivative) algorithm implemented by a PID (proportional-integral-derivative) controller.

In these aspects, a standalone volumetric flow meter may be eliminated. The elimination of volumetric flow meter devices has a number of outstanding advantages including no rotating mechanical parts, no hotmelt system pressure lost, no reduction of mass density effects, and/or the like.

By using a static mixer, it is possible to have a homogenous adhesive flow in the flow channel to increase flow data accuracy. The static mixer reduces the negative influences of viscosity and temperature changes of the molten adhesive in the flow channel based on the convection anemometry flow sensing measurement.

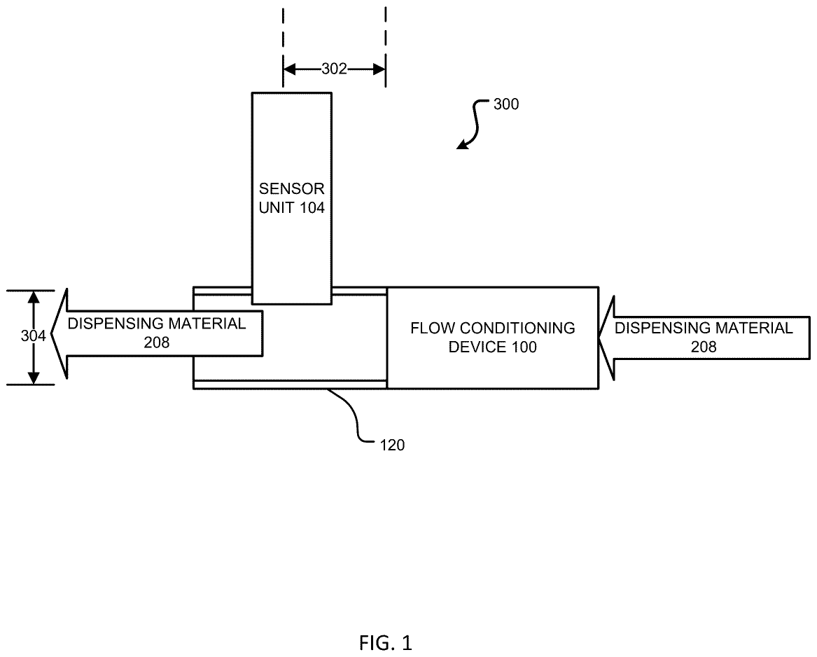

FIG. 1 schematically illustrates a flow conditioning device implemented with a sensor unit according to aspects of the disclosure.

In particular, FIG. 1 illustrates a flow conditioning device 100 implemented with a sensor unit 104 according to aspects of the disclosure. Aspects illustrated in FIG. 1 may be implemented in any other aspect of the disclosure.

Moreover, aspects illustrated in FIG. 1 may include any other aspects as disclosed herein.

In this regard, the flow conditioning device 100 may receive a dispensing material 208. Thereafter, the flow conditioning device 100 may condition the dispensing material 208 as the dispensing material 208 travels through the flow conditioning device 100. In aspects, the flow conditioning device 100 may provide a more homogeneous laminar flow of the dispensing material 208 as the dispensing material 208 travels through the flow conditioning device 100. In aspects, the flow conditioning device 100 may mix, generate swirl, generate turbulence, and/or the like in the dispensing material 208 as the dispensing material 208 travels through the flow conditioning device 100. In aspects, the flow conditioning device 100 may be a mixing device and/or the like.

The dispensing material 208 may exit the flow conditioning device 100 and into a sensor channel 120. The sensor unit 104 may be arranged at least partially within the sensor channel 120 to measure characteristics of the dispensing material 208. In aspects, the sensor unit 104 may be implemented as a compact convection anemometry mass flow sensor.

Accordingly, the flow conditioning device 100 and the sensor channel 120 may be configured as a sensing device 300. In aspects, the sensing device 300 may further include other components as described herein. In aspects, the sensing device 300 may be configured as an adhesive sensing device.

In aspects, the sensing device 300 may mix the dispensing material 208 in the flow conditioning device 100 to equalize a thermal profile; and the sensing device 300 may thereafter direct the dispensing material 208 to the sensor channel 120 and/or the sensor unit 104. In this regard, equalizing the profile of the dispensing material 208 may provide better and/or more accurate temperature measurement, temperature sensing, and/or mass flow determination.

Accordingly, the flow conditioning device 100 is configured to provide a more homogenous laminar flow of the dispensing material 208 in the sensor channel 120. Thereafter, as the dispensing material 208 passes the sensor unit 104, the sensor unit 104 may measure a flow rate of the dispensing material 208 with greater accuracy. In these aspects, a standalone volumetric flow meter may be eliminated. The elimination of volumetric flow meter devices has a number of outstanding advantages including no rotating mechanical parts, no hotmelt system pressure lost, no reduction of mass density effects, and/or the like.

Further, to ensure that the sensor unit 104 receives a more homogeneous laminar flow of the dispensing material 208 in the sensor channel 120, the flow conditioning device 100 may be arranged upstream of the sensor channel 120 in proximity to the sensor unit 104. In aspects, the flow conditioning device 100 may be arranged upstream a distance 302 from a center of the sensor unit 104 as illustrated in FIG. 1. In aspects, the distance 302 may be proportional to a dimension 304 of the sensor channel 120 as illustrated in FIG. 1. The dimension 304 may be a radius of the sensor channel 120, a width of the sensor channel 120, and/or a height of the sensor channel 120. In aspects, the distance 302 may be less than the dimension 304. In aspects, the distance 302 may be greater than the dimension 304. In aspects, the distance 302 may be N times greater than the dimension 304. In aspects, N may be 2-50, 2-4, 4-6, 6-8, 8-10, 10-20, 20-30, 30-40, or 40-50.

In aspects, the sensor unit 104 may configured to implement a convection anemometry principle. In particular, the sensor unit 104 may output signals that may be utilized with constant-temperature algorithm (CTA: Constant Temperature Anemometer) that may use heat transfer to determine flow speed of the dispensing material 208. In aspects, the sensor unit 104 may include sensor plates arranged within the sensor channel 120. The sensor plates of the sensor unit 104 may include a heated sensor plate and/or a temperature sensor plate. In aspects, as the dispensing material 208 passes across the sensor plates of the sensor unit 104, heat is carried from the heated sensor plate to the dispensing material 208. Thereafter, the temperature sensor plate may sense the temperature of the dispensing material 208. The heated sensor plate of the sensor unit 104 and the temperature sensor plate of the sensor unit 104 may generate heater and sensor feedback signals.

The amount of heat that is transferred is a function of a flow increase or flow decrease of the dispensing material 208. By knowing the heat transfer amount, a mass flow rate of the dispensing material 208 may be determined and calculated from an amount of electrical energy compensation needed to maintain a constant temperature differential in a closed-loop control system. The heater and sensor feedback signals may be controlled by a closed-loop system with PID (proportional-integral-derivative) algorithm implemented by a PID (proportional-integral-derivative) controller.

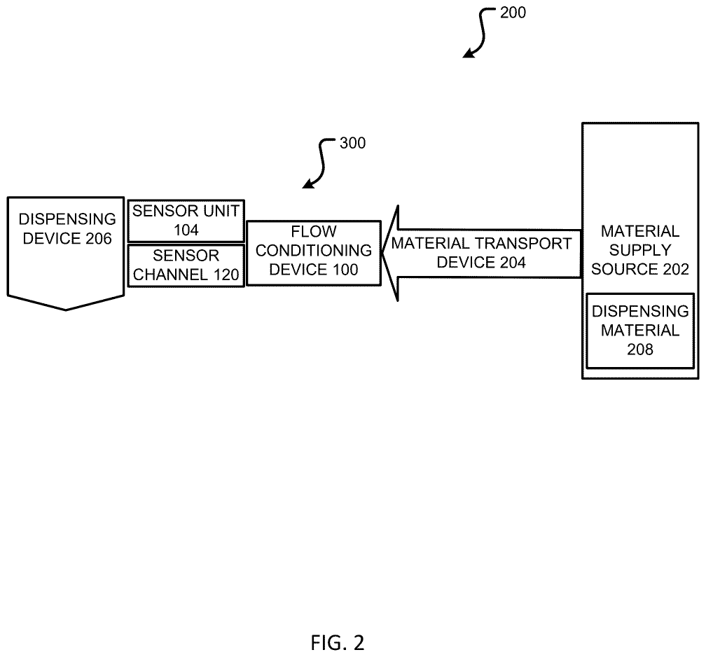

FIG. 2 schematically illustrates the flow conditioning device implemented in a system according to aspects of the disclosure.

In particular, FIG. 2 illustrates the flow conditioning device 100 implemented in a dispensing system 200 according to aspects of the disclosure. Aspects illustrated in FIG. 2 may be implemented in any other aspect of the disclosure. Moreover, aspects illustrated in FIG. 2 may include any other aspects as disclosed herein.

The dispensing system 200 may include a material supply source 202, a material transport device 204, a dispensing device 206, and/or the like. The material supply source 202 may supply a source of the dispensing material 208 to the material transport device 204. The material transport device 204 may transport the dispensing material 208 to the static mixer adapter unit 102 and the flow conditioning device 100. Thereafter, the flow conditioning device 100 may deliver the dispensing material 208 to the sensor channel 120, the sensor unit 104, and the dispensing device 206.

In aspects, the flow conditioning device 100 may be arranged in the dispensing device 206, the material transport device 204, or another component of the dispensing system 200. In aspects, the sensor unit 104 may be arranged in the dispensing device 206, the material transport device 204, or another component of the dispensing system 200. In aspects, the sensor channel 120 may be arranged in the dispensing device 206, the material transport device 204, or another component of the dispensing system 200.

Accordingly, the flow conditioning device 100 and the sensor channel 120 may be configured as the sensing device 300. In aspects, the sensing device 300 may further include the dispensing device 206, the material transport device 204, and/or another component of the dispensing system 200. In aspects, the sensing device 300 may be configured as an adhesive sensing device.

In aspects, the sensing device 300 may mix the dispensing material 208 in the flow conditioning device 100 to equalize a thermal profile; and the sensing device 300 may thereafter direct the dispensing material 208 to the sensor channel 120 and/or the sensor unit 104. In this regard, equalizing the profile of the dispensing material 208 may provide better and/or more accurate temperature measurement, temperature sensing, and/or mass flow determination.

Accordingly, the flow conditioning device 100 may be configured to provide a more homogenous laminar flow of the dispensing material 208 in the sensor channel 120. Thereafter, as the dispensing material 208 passes the sensor unit 104, the sensor unit 104 may measure a flow rate of the dispensing material 208 with greater accuracy. In these aspects, a standalone volumetric flow meter may be eliminated. The elimination of volumetric flow meter devices has a number of outstanding advantages including no rotating mechanical parts, no hotmelt system pressure lost, no reduction of mass density effects, and/or the like.

In particular aspects, the dispensing system 200 may be a flowable material dispensing system, an adhesive dispensing system, a hotmelt adhesive dispensing system, and/or the like. In particular aspects, the material supply source 202 may be a flowable material source, an adhesive source, a hot melt adhesive source, an adhesive melter, a hot melt adhesive melter, a pump, a flowable material pump, an adhesive pump, a hot melt adhesive pump, and/or the like. In particular aspects, the dispensing device 206 may be a material dispenser, an adhesive dispenser, a hotmelt dispenser, and/or the like. In aspects, the material transport device 204 may be a transport hose, an adhesive transport hose, a hotmelt adhesive transport hose, a manifold, an adhesive manifold, a hotmelt adhesive manifold, and/or the like. In aspects, the dispensing material 208 may be an adhesive, a hotmelt adhesive, and/or the like.

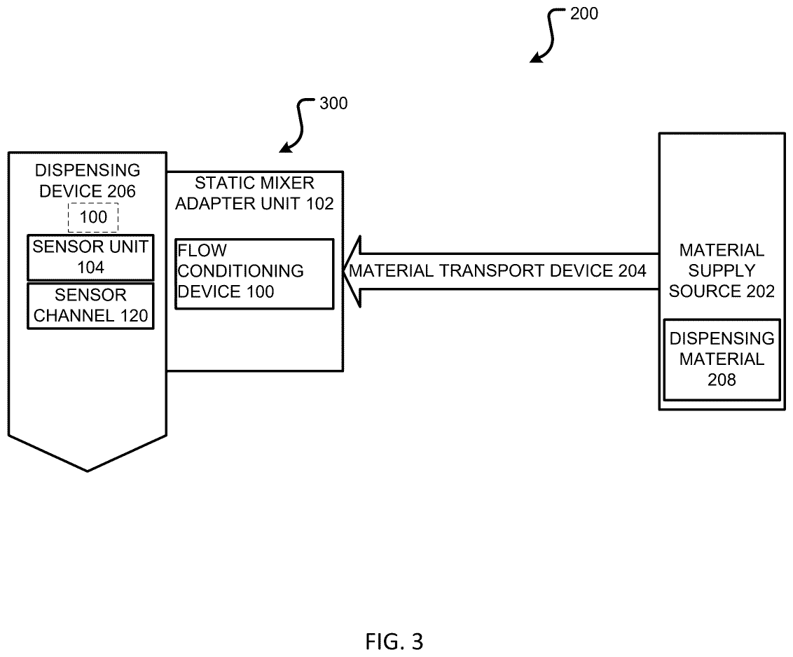

FIG. 3 schematically illustrates the flow conditioning device implemented in a system according to aspects of the disclosure.

In particular, FIG. 3 illustrates the flow conditioning device 100 implemented in the dispensing system 200 according to aspects of the disclosure. Aspects illustrated in FIG. 3 may be implemented in any other aspect of the disclosure. Moreover, aspects illustrated in FIG. 3 may include any other aspects as disclosed herein.

In particular, FIG. 3 illustrates the flow conditioning device 100 may be implemented in a static mixer adapter unit 102. Moreover, FIG. 3 illustrates that the flow conditioning device 100 and the static mixer adapter unit 102 may be implemented in the dispensing system 200. The material transport device 204 may transport the dispensing material 208 to the static mixer adapter unit 102 and the flow conditioning device 100. Thereafter, the flow conditioning device 100 may deliver the dispensing material 208 with a more homogenous laminar flow to the sensor channel 120, the sensor unit 104, and the dispensing device 206. As illustrated in FIG. 3, the sensor unit 104 and the sensor channel 120 may be integrated into the dispensing device 206. In other aspects, the sensor unit 104, the sensor channel 120, and the flow conditioning device 100 (illustrated by the dashed box) may be integrated into the dispensing device 206. In a particular aspect, the flow conditioning device 100 may be integrated into a flow channel of the dispensing device 206. In a particular aspect, the flow conditioning device 100 may be integrated into an applicator manifold of the dispensing device 206.

Accordingly, the flow conditioning device 100 and the sensor channel 120 may be configured as the sensing device 300. In aspects, the sensing device 300 may further include the static mixer adapter unit 102, the dispensing device 206, the material transport device 204, and/or another component of the dispensing system 200. In aspects, the sensing device 300 may be configured as an adhesive sensing device.

In aspects, the sensing device 300 may mix the dispensing material 208 in the flow conditioning device 100 to equalize a thermal profile; and the sensing device 300 may thereafter direct the dispensing material 208 to the sensor channel 120 and/or the sensor unit 104. In this regard, equalizing the profile of the dispensing material 208 may provide better and/or more accurate temperature measurement, temperature sensing, and/or mass flow determination.

In aspects of the disclosure, the static mixer adapter unit 102 may be heated. In other aspects, the static mixer adapter unit 102 may not be heated. Further, the sensor unit 104 may be arranged in the dispensing device 206 for direct sensing of a flow of the dispensing material 208 in the sensor channel 120 at the application point to increase flow data accuracy.

In particular aspects, the static mixer adapter unit 102 may be placed between the dispensing device 206 and the material transport device 204. More specifically, at one side the dispensing material 208 flows from the material transport device 204 into the static mixer adapter unit 102. The dispensing material 208 passes the flow conditioning device 100. The flow conditioning device 100 causes the dispensing material 208 to have a more homogenous laminar flow in a flow channel of the static mixer adapter unit 102. Then, the dispensing material 208 may enter the sensor channel 120 and may pass the sensor unit 104 integrated into the dispensing device 206 to measure the mass flow of the dispensing material 208 within the dispensing device 206.

Accordingly, the flow conditioning device 100 may be configured to provide a more homogenous laminar flow of the dispensing material 208 in the sensor channel 120. Thereafter, as the dispensing material 208 passes the sensor unit 104, the sensor unit 104 may measure a flow rate of the dispensing material 208 with greater accuracy. In these aspects, a standalone volumetric flow meter may be eliminated. The elimination of volumetric flow meter devices has a number of outstanding advantages including no rotating mechanical parts, no hotmelt system pressure lost, no reduction of mass density effects, and/or the like.

In particular aspects, the dispensing system 200 may be a flowable material dispensing system, an adhesive dispensing system, a hotmelt adhesive dispensing system, and/or the like. In particular aspects, the material supply source 202 may be a flowable material source, an adhesive source, a hot melt adhesive source, an adhesive melter, a hot melt adhesive melter, a pump, a flowable material pump, an adhesive pump, a hot melt adhesive pump, and/or the like. In particular aspects, the dispensing device 206 may be a material dispenser, an adhesive dispenser, a hotmelt dispenser, and/or the like. In aspects, the material transport device 204 may be a transport hose, an adhesive transport hose, a hotmelt adhesive transport hose, a manifold, an adhesive manifold, a hotmelt adhesive manifold, and/or the like. In aspects, the dispensing material 208 may be an adhesive, a hotmelt adhesive, and/or the like.

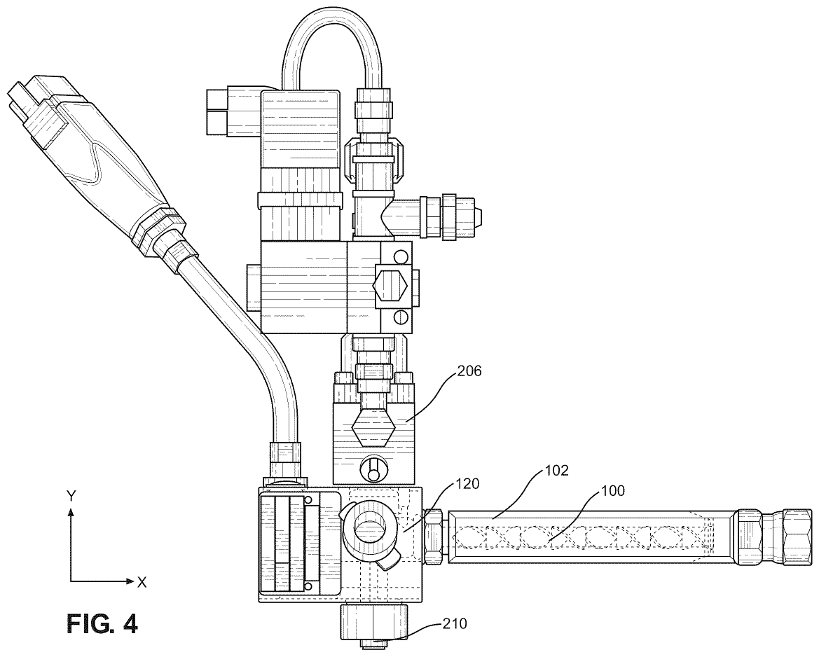

FIG. 4 illustrates a side view of an exemplary implementation of the flow conditioning device and the dispensing device according to aspects of the disclosure.

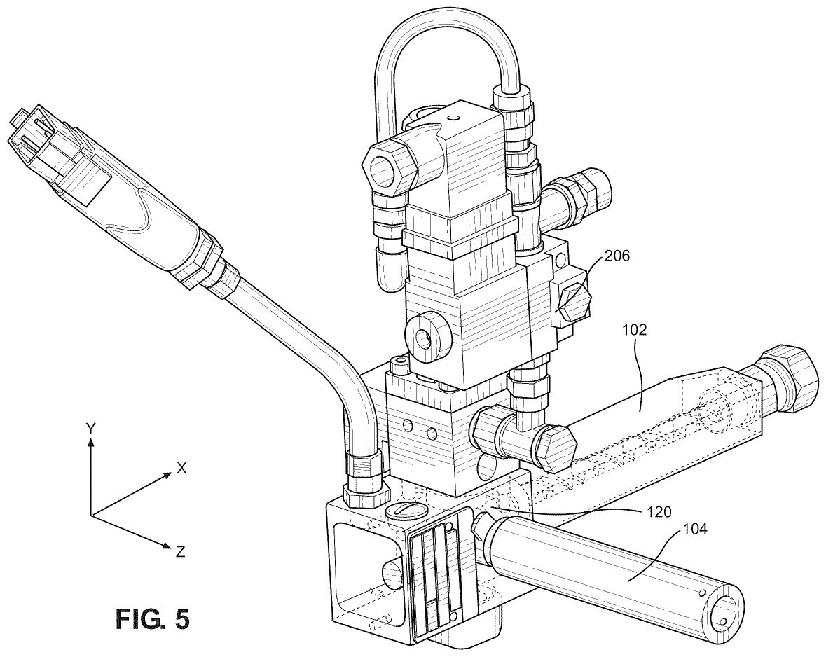

FIG. 5 illustrates a perspective view of the exemplary implementation of the flow conditioning device, the sensor unit, and the dispensing device according to FIG. 4.

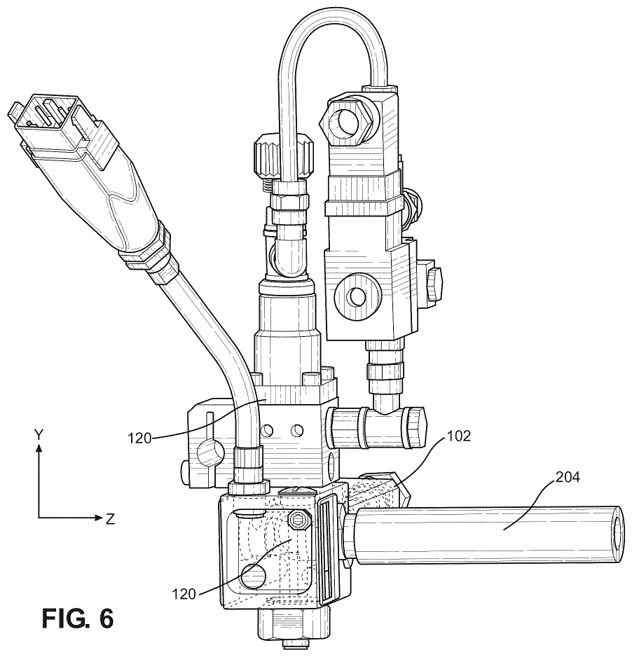

FIG. 6 illustrates a perspective view of the exemplary implementation of the flow conditioning device, the sensor unit, and the dispensing device according to FIG. 4.

In particular, FIG. 4, FIG. 5, and FIG. 6 illustrate an exemplary implementation of the flow conditioning device 100, the sensor unit 104, and the dispensing device 206. Aspects illustrated in FIG. 4, FIG. 5, and FIG. 6 may be implemented in any other aspect of the disclosure. Moreover, aspects illustrated in FIG. 4, FIG. 5, and FIG. 6 may include any other aspects as disclosed herein.

As illustrated in FIG. 4, FIG. 5, and FIG. 6 the flow conditioning device 100 and the static mixer adapter unit 102 may be attached to the dispensing device 206. In particular, FIG. 3 illustrates that the static mixer adapter unit 102 may be attached to the dispensing device 206 extending from the dispensing device 206 along the x-axis. Moreover, the sensor channel 120 may be integrated into the dispensing device 206. Further, the sensor channel 120 may be structured and arranged in proximity to the flow conditioning device 100 and/or the static mixer adapter unit 102. As illustrated in FIG. 5, the sensor unit 104 may be attached to the dispensing device 206. In particular, the sensor unit 104 may extend from the dispensing device 206 along the z-axis. Further, the sensor unit 104 may be arranged at least partially within the sensor channel 120.

Accordingly, the flow conditioning device 100 and/or the static mixer adapter unit 102 may be configured to provide a more homogenous laminar flow of the dispensing material 208 in the sensor channel 120. Thereafter, as the dispensing material 208 passes the sensor unit 104, the sensor unit 104 may measure a flow rate of the dispensing material 208 with greater accuracy. In these aspects, a standalone volumetric flow meter may be eliminated. The elimination of volumetric flow meter devices has a number of outstanding advantages including no rotating mechanical parts, no hotmelt system pressure lost, no reduction of mass density effects, and/or the like.

In aspects, the dispensing device 206 may have a nozzle arrangement 210 which delivers the dispensing material 208 to a substrate or workpiece (not shown). The dispensing device 206 may include a housing, flow channels formed therein, a valve arrangement and connections for introducing the dispensing material 208 from the static mixer adapter unit 102, a control device for controlling the material transport device 204 and further components.

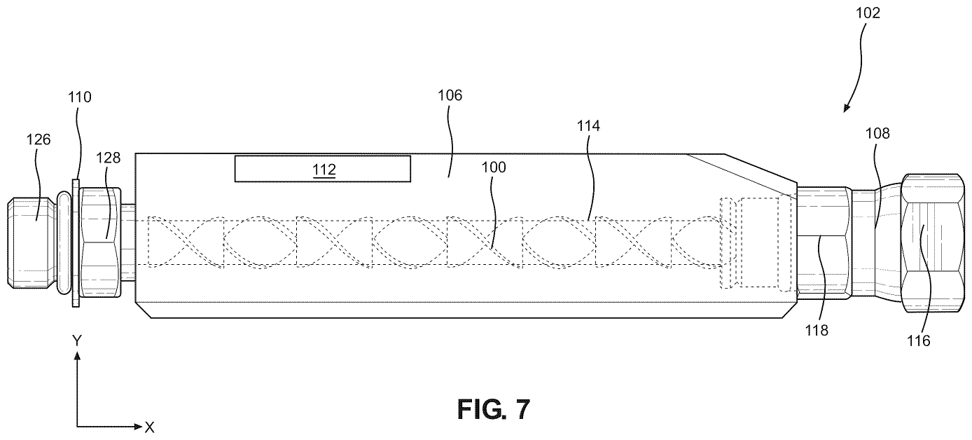

FIG. 7 illustrates a partial side view in partial transparent side view of an exemplary implementation of the flow conditioning device and the static mixer adapter unit according to aspects of the disclosure.

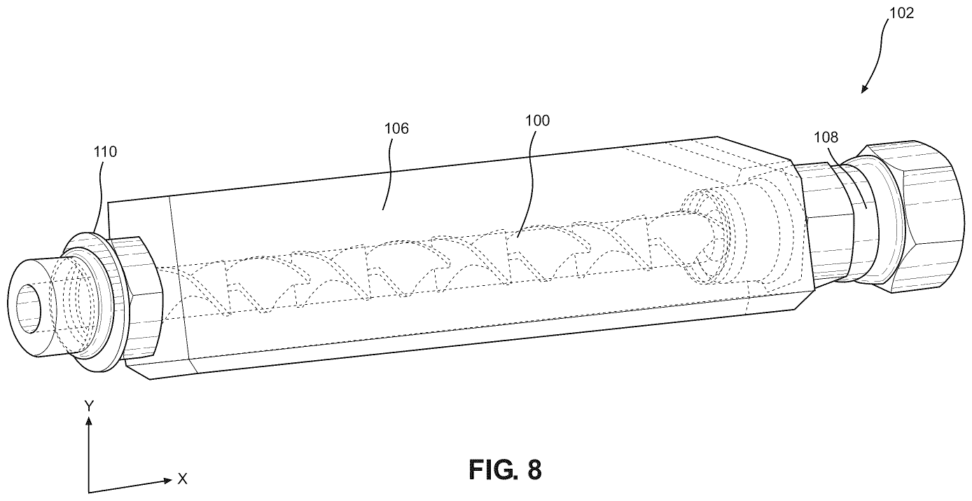

FIG. 8 illustrates a partial perspective view and partial transparent perspective view of an exemplary implementation of the flow conditioning device and the static mixer adapter unit according to FIG. 7.

In particular, FIG. 7 and FIG. 8 illustrate exemplary implementations of the flow conditioning device 100 and the static mixer adapter unit 102. Aspects illustrated in FIG. 7 and FIG. 8 may be implemented in any other aspect of the disclosure. Moreover, aspects illustrated in FIG. 7 and FIG. 8 may include any other aspects as disclosed herein.

In aspects, the static mixer adapter unit 102 may include a housing 106 configured to house the flow conditioning device 100. Additionally, the housing 106 may include a heating device 112. The heating device 112 may be configured to heat the static mixer adapter unit 102, the dispensing material 208 flowing through the static mixer adapter unit 102, the flow conditioning device 100, and/or the like.

In further aspects, the housing 106 may include a flow channel 114. The flow channel 114 may have the flow conditioning device 100 arranged therein. In particular, the flow channel 114 may extend a length of the housing 106 of the static mixer adapter unit 102 along the x-axis and the flow conditioning device 100 may extend a majority the length of the flow channel 114 along the x-axis.

Further, the flow conditioning device 100 may have any type configuration. In aspects, the flow conditioning device 100 may include a number of elements extending a length thereof to form a more homogenous laminar flow of the dispensing material 208 as it flows through the flow channel 114 of the static mixer adapter unit 102. In aspects, the elements of the flow conditioning device 100 may be mixing elements and/or the like to form a more homogenous laminar flow of the dispensing material 208. The mixing elements may be arranged within the flow conditioning device 100. The mixing elements may divide a flow of the dispensing material 208, fold a flow of the dispensing material 208, mix a flow of the dispensing material 208, combine a flow of the dispensing material 208, swirl a flow of the dispensing material 208, and/or the like.

Additionally, the static mixer adapter unit 102 may include a first connector 108. The first connector 108 may be configured to connect the static mixer adapter unit 102 to the material transport device 204, such as a hose. Accordingly, the first connector 108 may receive the dispensing material 208 from the material transport device 204.

The first connector 108 may include a first end portion 116 arranged on one end of the first connector 108. The first end portion 116 may include a threaded portion configured to connect the first connector 108 to the material transport device 204. In this regard, the material transport device 204 may include a corresponding threaded portion to connect the material transport device 204 to the first end portion 116 of the first connector 108.

The first connector 108 may include a second end portion 118 on another opposite end of the first connector 108. The second end portion 118 may include a threaded portion configured to connect the first connector 108 to the housing 106. In this regard, the housing 106 may include a corresponding threaded portion to connect the housing 106 to the second end portion 118 of the first connector 108.

Additionally, the static mixer adapter unit 102 may include a second connector 110 that may be configured to connect the static mixer adapter unit 102 to the dispensing device 206. Accordingly, the first connector 108 may deliver the dispensing material 208 to the dispensing device 206.

The second connector 110 may include a first end portion 126 arranged on one end of the second connector 110. The first end portion 126 may include a portion configured to connect the second connector 110 to the dispensing device 206.

In this regard, the dispensing device 206 may include a corresponding portion to connect the dispensing device 206 to the first end portion 126 of the second connector 110.

The second connector 110 may include a second end portion 128 on another opposite end of the second connector 110. The second end portion 128 may include a threaded portion configured to connect the second connector 110 to the housing 106. In this regard, the housing 106 may include a corresponding threaded portion to connect the housing 106 to the second end portion 128 of the second connector 110.

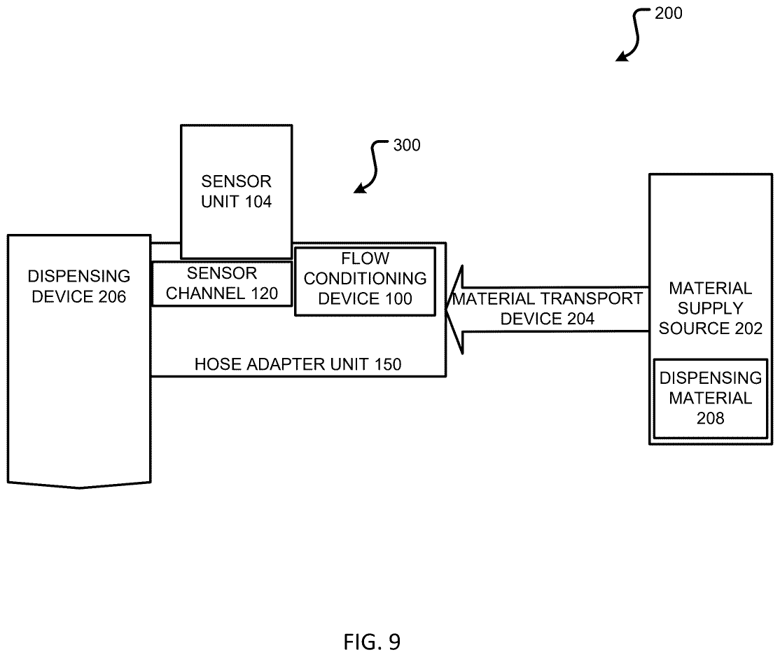

FIG. 9 schematically illustrates the flow conditioning device implemented in a system according to aspects of the disclosure.

In particular, FIG. 9 illustrates the flow conditioning device 100 implemented in the dispensing system 200 according to aspects of the disclosure.

Aspects illustrated in FIG. 9 may be implemented in any other aspect of the disclosure. Moreover, aspects illustrated in FIG. 9 may include any other aspects as disclosed herein.

In particular, FIG. 9 illustrates the flow conditioning device 100 may be implemented in a hose adapter unit 150. Moreover, FIG. 9 illustrates that the flow conditioning device 100 and the hose adapter unit 150 may be implemented in the dispensing system 200. The hose adapter unit 150 may include the sensor channel 120 and the sensor unit 104.

The material transport device 204 may transport the dispensing material 208 to the hose adapter unit 150 and the flow conditioning device 100. Thereafter, the flow conditioning device 100 may deliver the dispensing material 208 with a more homogeneous laminar flow to the sensor channel 120 and the sensor unit 104. As illustrated in FIG. 9, the sensor unit 104 and the sensor channel 120 may be integrated into the hose adapter unit 150. Thereafter, the dispensing material 208 may be delivered from the hose adapter unit 150 to the dispensing device 206.

In aspects of the disclosure, the hose adapter unit 150 may be heated. In other aspects, the hose adapter unit 150 may not be heated. Further, the sensor unit 104 may be arranged in the hose adapter unit 150 for direct sensing of a flow of the dispensing material 208 in the sensor channel 120.

In particular aspects, the hose adapter unit 150 may be placed between the dispensing device 206 and the material transport device 204. More specifically, at one side the dispensing material 208 flows from the material transport device 204 into the hose adapter unit 150. The dispensing material 208 passes the flow conditioning device 100. The flow conditioning device 100 causes the dispensing material 208 to have a more homogenous laminar flow in a flow channel of the hose adapter unit 150. Then, the dispensing material 208 may enter the sensor channel 120 and may pass the sensor unit 104 integrated into the hose adapter unit 150 to measure the mass flow of the dispensing material 208 within the hose adapter unit 150.

Accordingly, the flow conditioning device 100 and the sensor channel 120 may be configured as the sensing device 300. In aspects, the sensing device 300 may further include the hose adapter unit 150, the dispensing device 206, the material transport device 204, and/or another component of the dispensing system 200. In aspects, the sensing device 300 may be configured as an adhesive sensing device.

In aspects, the sensing device 300 may mix the dispensing material 208 in the flow conditioning device 100 to equalize a thermal profile; and the sensing device 300 may thereafter direct the dispensing material 208 to the sensor channel 120 and/or the sensor unit 104. In this regard, equalizing the profile of the dispensing material 208 may provide better and/or more accurate temperature measurement, temperature sensing, and/or mass flow determination.

Accordingly, the flow conditioning device 100 may be configured to provide a more homogenous laminar flow of the dispensing material 208 in the sensor channel 120. Thereafter, as the dispensing material 208 passes the sensor unit 104, the sensor unit 104 may measure a flow rate of the dispensing material 208 with greater accuracy. In these aspects, a standalone volumetric flow meter may be eliminated. The elimination of volumetric flow meter devices has a number of outstanding advantages including no rotating mechanical parts, no hotmelt system pressure lost, no reduction of mass density effects, and/or the like.

In particular aspects, the dispensing system 200 may be a flowable material dispensing system, an adhesive dispensing system, a hotmelt adhesive dispensing system, and/or the like. In particular aspects, the material supply source 202 may be a flowable material source, an adhesive source, a hot melt adhesive source, an adhesive melter, a hot melt adhesive melter, a pump, a flowable material pump, an adhesive pump, a hot melt adhesive pump, and/or the like. In particular aspects, the dispensing device 206 may be a material dispenser, an adhesive dispenser, a hotmelt dispenser, and/or the like. In aspects, the material transport device 204 may be a transport hose, an adhesive transport hose, a hotmelt adhesive transport hose, a manifold, an adhesive manifold, a hotmelt adhesive manifold, and/or the like. In aspects, the dispensing material 208 may be an adhesive, a hotmelt adhesive, and/or the like.

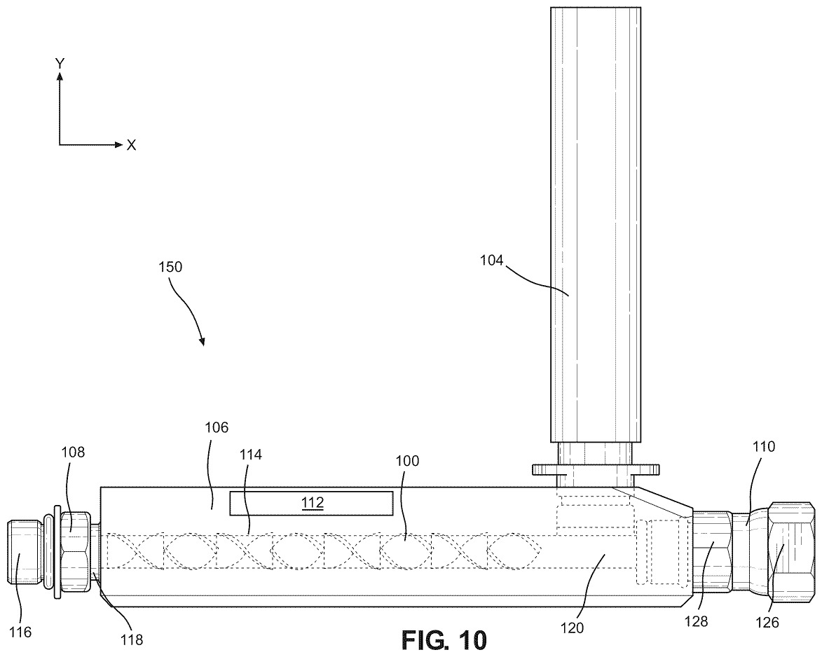

FIG. 10 illustrates a partial side view in partial transparent side view of an exemplary implementation of the flow conditioning device and the hose adapter unit according to aspects of the disclosure.

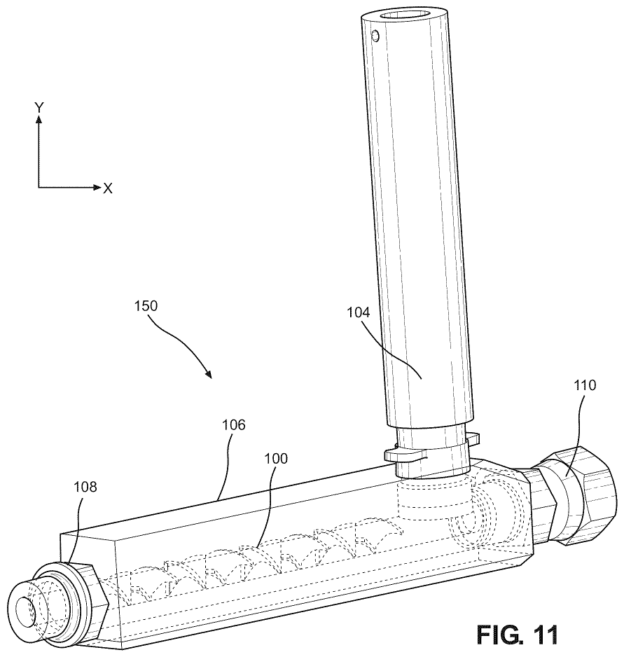

FIG. 11 illustrates a partial perspective view and partial transparent perspective view of an exemplary implementation of the flow conditioning device and the hose adapter unit according to FIG. 10.

In particular, FIG. 10 and FIG. 11 illustrates exemplary implementations of the flow conditioning device 100 and the hose adapter unit 150. Aspects illustrated in FIG. 10 and FIG. 11 may be implemented in any other aspect of the disclosure. Moreover, aspects illustrated in FIG. 10 and FIG. 11 may include any other aspects as disclosed herein.

In particular, the hose adapter unit 150 may include the sensor unit 104 and the sensor channel 120 integrated therein. Accordingly, the flow conditioning device 100 and/or the hose adapter unit 150 may be configured to provide a more homogenous laminar flow of the dispensing material 208 in the sensor channel 120. Thereafter, as the dispensing material 208 passes the sensor unit 104, the sensor unit 104 may measure a flow rate of the dispensing material 208 with greater accuracy. In these aspects, a standalone volumetric flow meter may be eliminated. The elimination of volumetric flow meter devices has a number of outstanding advantages including no rotating mechanical parts, no hotmelt system pressure lost, no reduction of mass density effects, and/or the like.

In aspects, the hose adapter unit 150 may include the housing 106, the flow channel 114, the first connector 108, the first end portion 116, the second end portion 118, the second connector 110, the first end portion 126, the second end portion 128, and/or the like in a similar manner to the static mixer adapter unit 102.

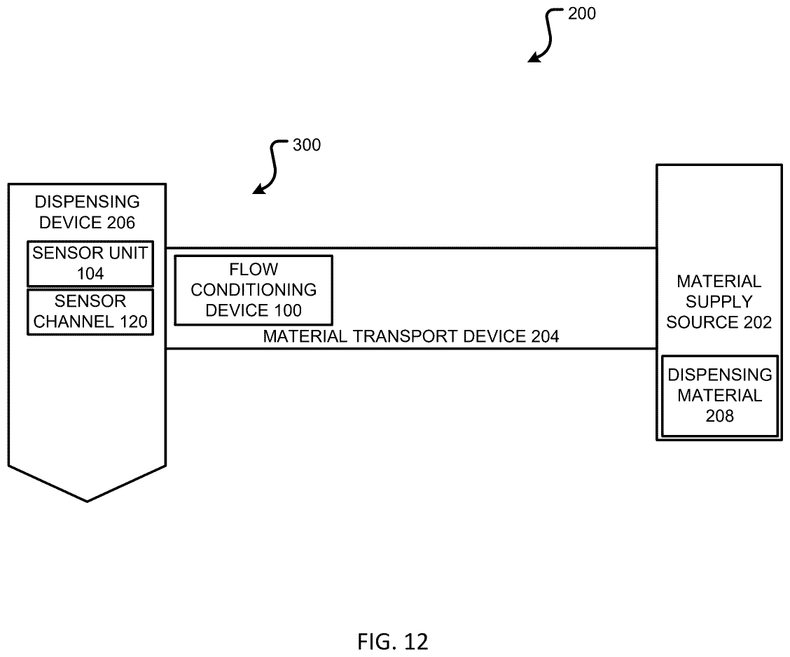

FIG. 12 schematically illustrates the flow conditioning device implemented in a system according to aspects of the disclosure.

In particular, FIG. 12 illustrates the flow conditioning device 100 implemented in the dispensing system 200 according to aspects of the disclosure.

Aspects illustrated in FIG. 12 may be implemented in any other aspect of the disclosure. Moreover, aspects illustrated in FIG. 12 may include any other aspects as disclosed herein.

In particular, FIG. 12 illustrates the flow conditioning device 100 may be implemented in the material transport device 204. Moreover, FIG. 12 illustrates that the flow conditioning device 100 and the material transport device 204 may be implemented in the dispensing system 200. In particular, FIG. 12 illustrates that the flow conditioning device 100 may be integrated into the material transport device 204. In particular aspects, the flow conditioning device 100 may be integrated into the material transport device 204 adjacent the dispensing device 206.

The material transport device 204 may transport the dispensing material 208 to the flow conditioning device 100. Thereafter, the flow conditioning device 100 may deliver the dispensing material 208 with a more homogeneous laminar flow to the sensor channel 120, the sensor unit 104, and the dispensing device 206. As illustrated in FIG. 12, the sensor unit 104 and the sensor channel 120 may be integrated into the dispensing device 206.

More specifically, at one side the dispensing material 208 flows in the material transport device 204 and into the flow conditioning device 100 integrated within the material transport device 204. The dispensing material 208 passes the flow conditioning device 100. The flow conditioning device 100 causes the dispensing material 208 to have a more homogenous laminar flow in a flow channel of the material transport device 204. Then, the dispensing material 208 may exit the flow conditioning device 100 and/or the material transport device 204; and the dispensing material 208 may enter the sensor channel 120 and may pass the sensor unit 104 integrated into the dispensing device 206 to measure the mass flow of the dispensing material 208 within the dispensing device 206.

In aspects of the disclosure, the material transport device 204 may be heated. Further, the sensor unit 104 may be arranged in the dispensing device 206 for direct sensing of a flow of the dispensing material 208 in the sensor channel 120 at the application point to increase flow data accuracy.

Accordingly, the flow conditioning device 100 and the sensor channel 120 may be configured as the sensing device 300. In aspects, the sensing device 300 may further include the dispensing device 206, the material transport device 204, and/or another component of the dispensing system 200. In aspects, the sensing device 300 may be configured as an adhesive device.

In aspects, the sensing device 300 may mix the dispensing material 208 in the flow conditioning device 100 to equalize a thermal profile; and the sensing device 300 may thereafter direct the dispensing material 208 to the sensor channel 120 and/or the sensor unit 104. In this regard, equalizing the profile of the dispensing material 208 may provide better and/or more accurate temperature measurement, temperature sensing, and/or mass flow determination.

Accordingly, the flow conditioning device 100 may be configured to provide a more homogenous laminar flow of the dispensing material 208 in the sensor channel 120. Thereafter, as the dispensing material 208 passes the sensor unit 104, the sensor unit 104 may measure a flow rate of the dispensing material 208 with greater accuracy. In these aspects, a standalone volumetric flow meter may be eliminated. The elimination of volumetric flow meter devices has a number of outstanding advantages including no rotating mechanical parts, no hotmelt system pressure lost, no reduction of mass density effects, and/or the like.

In particular aspects, the dispensing system 200 may be a flowable material dispensing system, an adhesive dispensing system, a hotmelt adhesive dispensing system, and/or the like. In particular aspects, the material supply source 202 may be a flowable material source, an adhesive source, a hot melt adhesive source, an adhesive melter, a hot melt adhesive melter, a pump, a flowable material pump, an adhesive pump, a hot melt adhesive pump, and/or the like. In particular aspects, the dispensing device 206 may be a material dispenser, an adhesive dispenser, a hotmelt dispenser, and/or the like. In aspects, the material transport device 204 may be a transport hose, an adhesive transport hose, a hotmelt adhesive transport hose, a manifold, an adhesive manifold, a hotmelt adhesive manifold, and/or the like. In aspects, the dispensing material 208 may be an adhesive, a hotmelt adhesive, and/or the like.

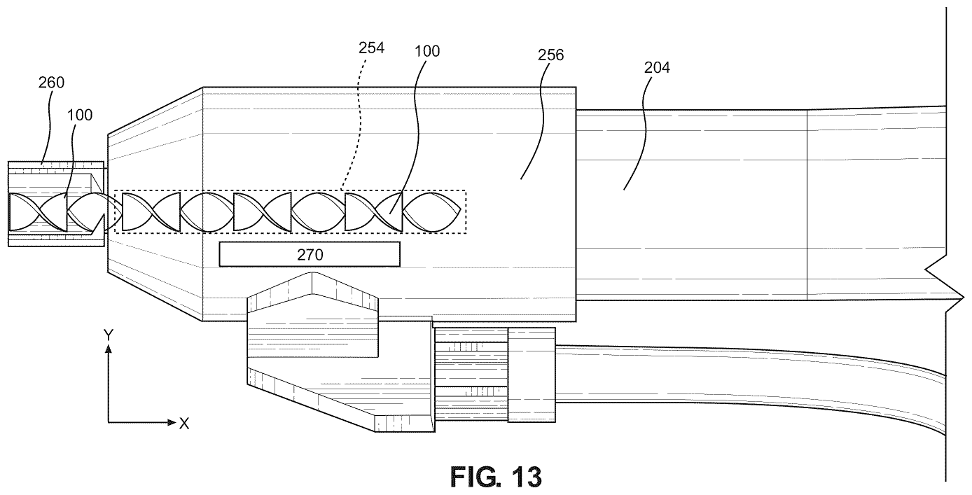

FIG. 13 illustrates a partial side view and a partial transparent side view of an exemplary implementation of the flow conditioning device and the material transport device according to aspects of the disclosure.

In particular, FIG. 13 illustrates exemplary implementations of the flow conditioning device 100 and the material transport device 204. Aspects illustrated in FIG. 13 may be implemented in any other aspect of the disclosure. Moreover, aspects illustrated in FIG. 13 may include any other aspects as disclosed herein.

In aspects, the material transport device 204 may include a housing 256 configured to house the flow conditioning device 100. Additionally, the housing 256 may include a heating device 270. The heating device 270 may be configured to heat the material transport device 204, the dispensing material 208 flowing through the material transport device 204, the flow conditioning device 100, and/or the like.

In further aspects, the housing 256 may include a flow channel 254. The flow channel 254 may have the flow conditioning device 100 arranged therein. In particular, the flow channel 254 may extend a length or a partial length of the housing 256 along the x-axis and the flow conditioning device 100 may extend a majority the length of the flow channel 254 along the x-axis.

Additionally, the material transport device 204 and/or the housing 256 may include a connector 260 that may be configured to connect the material transport device 204 to the dispensing device 206. Accordingly, the connector 260 may deliver the dispensing material 208 to the dispensing device 206.

In further aspects, the flow conditioning device 100 may extend from the flow channel 254 and/or the housing 256 into the connector 260. In further aspects, the flow conditioning device 100 may extend from the flow channel 254 and/or the housing 256 into the connector 260 and extend from the connector 260.

Further, the flow conditioning device 100 may have any type configuration. In aspects, the flow conditioning device 100 may include a number of elements extending a length thereof to form a more homogenous laminar flow of the dispensing material 208 as it flows through the flow channel 254. In aspects, the elements of the flow conditioning device 100 may be mixing elements and/or the like to form a more homogenous laminar flow of the dispensing material 208. The mixing elements may be arranged within the flow conditioning device 100. The mixing elements may divide a flow of the dispensing material 208, fold a flow of the dispensing material 208, mix a flow of the dispensing material 208, combine a flow of the dispensing material 208, swirl a flow of the dispensing material 208, and/or the like.

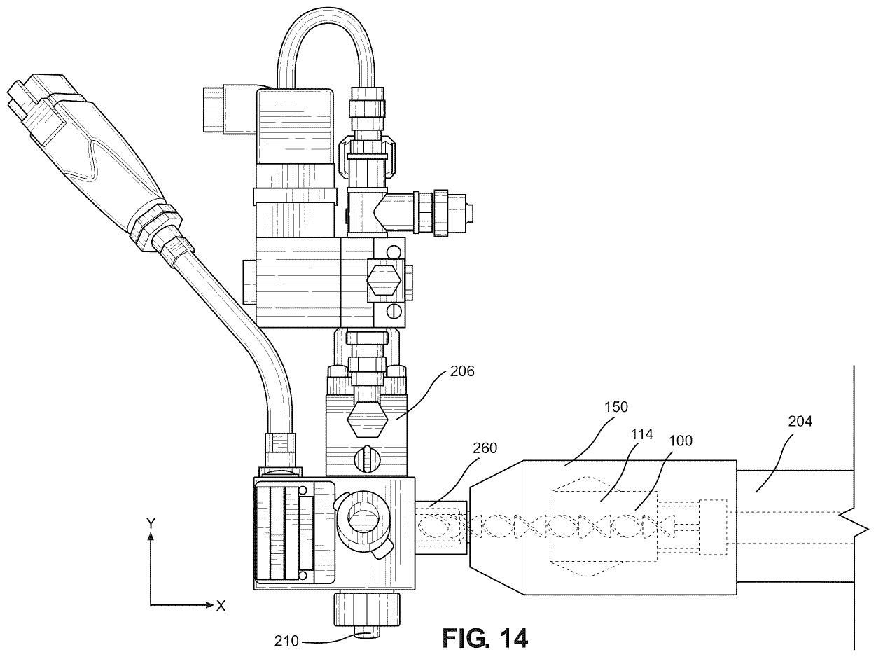

FIG. 14 illustrates a side view of an exemplary implementation of the flow conditioning device, the material transport device, and the dispensing device according to aspects of the disclosure.

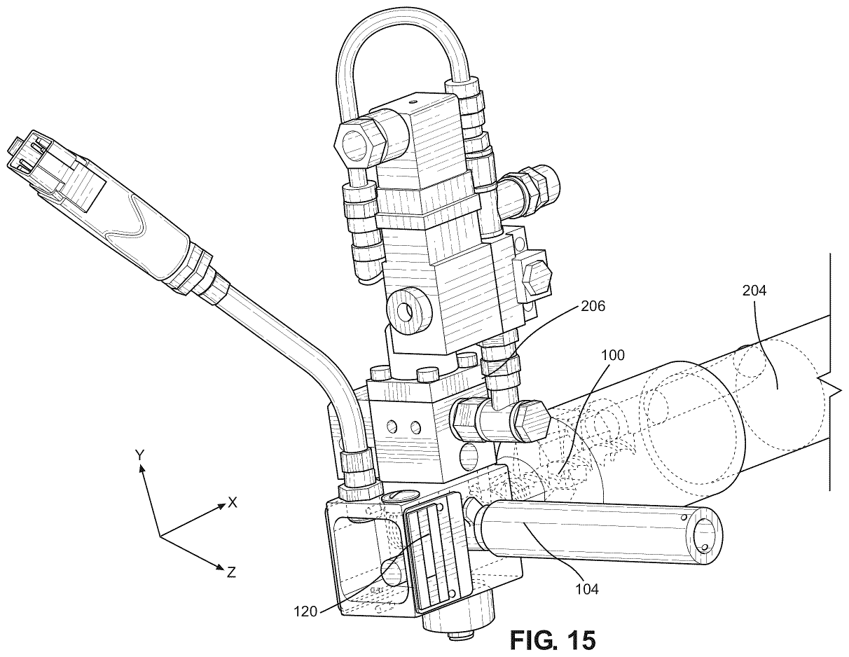

FIG. 15 illustrates a perspective view of the exemplary implementation of the flow conditioning device, the sensor unit, the material transport device, and the dispensing device according to FIG. 14.

In particular, FIG. 14 and FIG. 15 illustrate an exemplary implementation of the flow conditioning device 100, the sensor unit 104, and the dispensing device 206. Aspects illustrated in FIG. 14 and FIG. 15 may be implemented in any other aspect of the disclosure. Moreover, aspects illustrated in FIG. 14 and FIG. 15 may include any other aspects as disclosed herein.

As illustrated in FIG. 14 and FIG. 15 the flow conditioning device 100 and the material transport device 204 may be attached to the dispensing device 206. In particular, FIG. 14 illustrates that the material transport device 204 together with the flow conditioning device 100 may be attached to the dispensing device 206 extending from the dispensing device 206 along the x-axis. Moreover, the sensor channel 120 may be integrated into the dispensing device 206. Moreover, the sensor channel 120 may be structured and arranged in proximity to the flow conditioning device 100. As illustrated in FIG. 15, the sensor unit 104 may be attached to the dispensing device 206. In particular, the sensor unit 104 may extend from the dispensing device 206 along the z-axis. Further, the sensor unit 104 may be arranged at least partially within the sensor channel 120.

Accordingly, the flow conditioning device 100 integrated into the material transport device 204 may be configured to provide a more homogenous laminar flow of the dispensing material 208 in the sensor channel 120. Thereafter, as the dispensing material 208 passes the sensor unit 104, the sensor unit 104 may measure a flow rate of the dispensing material 208 with greater accuracy. In these aspects, a standalone volumetric flow meter may be eliminated. The elimination of volumetric flow meter devices has a number of outstanding advantages including no rotating mechanical parts, no hotmelt system pressure lost, no reduction of mass density effects, and/or the like.

In aspects, the dispensing device 206 may have a nozzle arrangement 210 which delivers the dispensing material 208 to a substrate or workpiece (not shown). The dispensing device 206 may include a housing, flow channels formed therein, a valve arrangement and connections for introducing the dispensing material 208 from the static mixer adapter unit 102, a control device for controlling the material transport device 204 and further components.

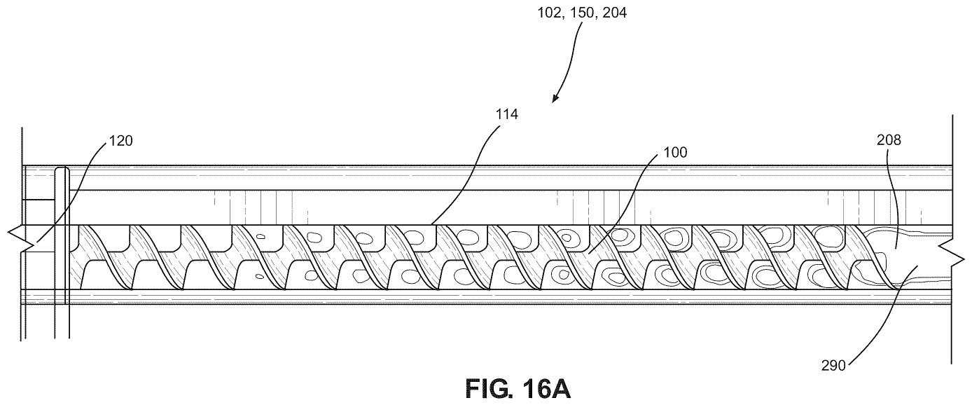

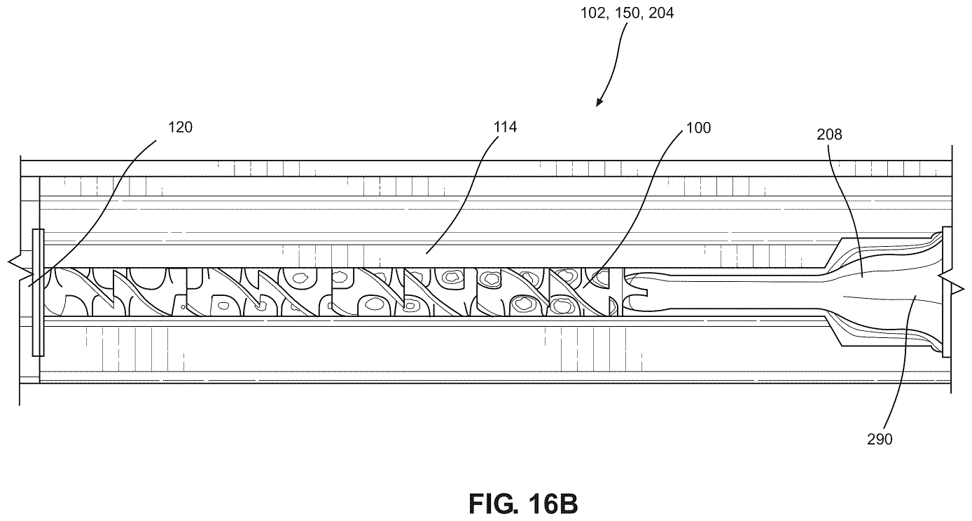

FIG. 16A and FIG. 16B illustrate flow and thermal profiles of the dispensing material within the flow channel as the dispensing material is homogenized by the flow conditioning device with the aspects of the disclosure.

In particular, FIG. 16A and FIG. 16B illustrate thermal profiles of the dispensing material 208 within the flow channel 114 as the dispensing material 208 is homogenized by the flow conditioning device 100 with the aspects of the disclosure. As illustrated in FIG. 16A and FIG. 16B, the dispensing material 208 may enter the flow conditioning device 100 in the static mixer adapter unit 102, the hose adapter unit 150, and/or the material transport device 204 at an end 290 thereof. In this regard, the dispensing material 208 at the end 290 is shown with a nonhomogeneous thermal profile. As the dispensing material 208 passes through the flow conditioning device 100 within the flow channel 114, the dispensing material 208 has a more and more homogeneous laminar flow. Thereafter, as the dispensing material 208 exits the flow conditioning device 100 and enters the sensor channel 120, the dispensing material 208 has a more homogeneous laminar flow due to the implementation of the flow conditioning device 100. Additionally, FIG. 16A and FIG. 16B each show different constructions of the mixing elements of the flow conditioning device 100. In this regard, the flow conditioning device 100 may have mixing elements with a spiral construction, mixing elements with a helix construction, and/or the like. The mixing elements may divide a flow of the dispensing material 208, fold a flow of the dispensing material 208, mix a flow of the dispensing material 208, combine a flow of the dispensing material 208, swirl a flow of the dispensing material 208, and/or the like.

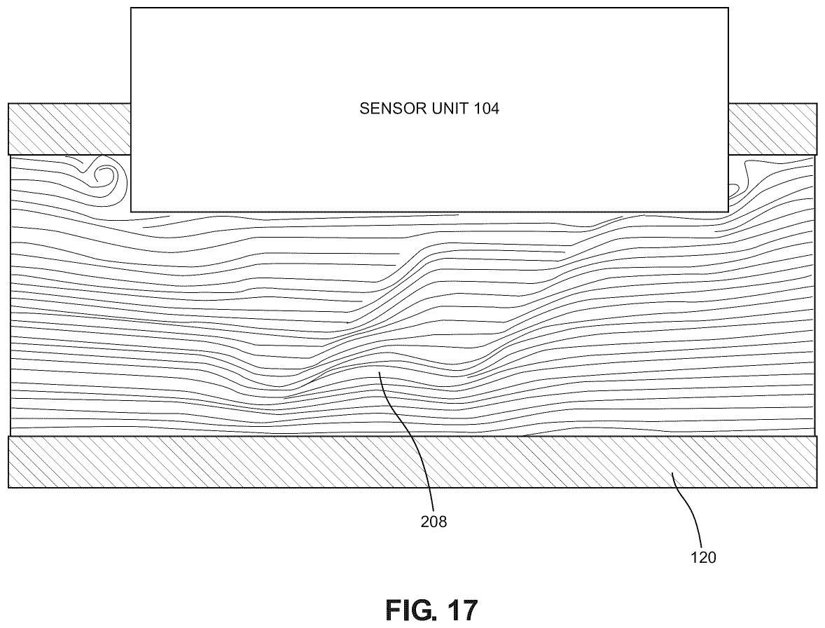

FIG. 17 illustrates a flow and thermal profile of the dispensing material within the sensor channel according to aspects of the disclosure.

In particular, FIG. 17 illustrates a flow and thermal profile of the dispensing material 208 within the sensor channel 120 according to aspects of the disclosure. In this regard, FIG. 17 further illustrates a location of the sensor unit 104 in proximity to the sensor channel 120.

In this regard, FIG. 17 illustrates that the variation of the flow and temperature of the dispensing material 208 within the sensor channel 120 after being processed by the flow conditioning device 100 has a very homogeneous nature. Likewise, in other operational configurations of the dispensing system 200, the flow and temperature of the dispensing material 208 would likewise vary minimally.

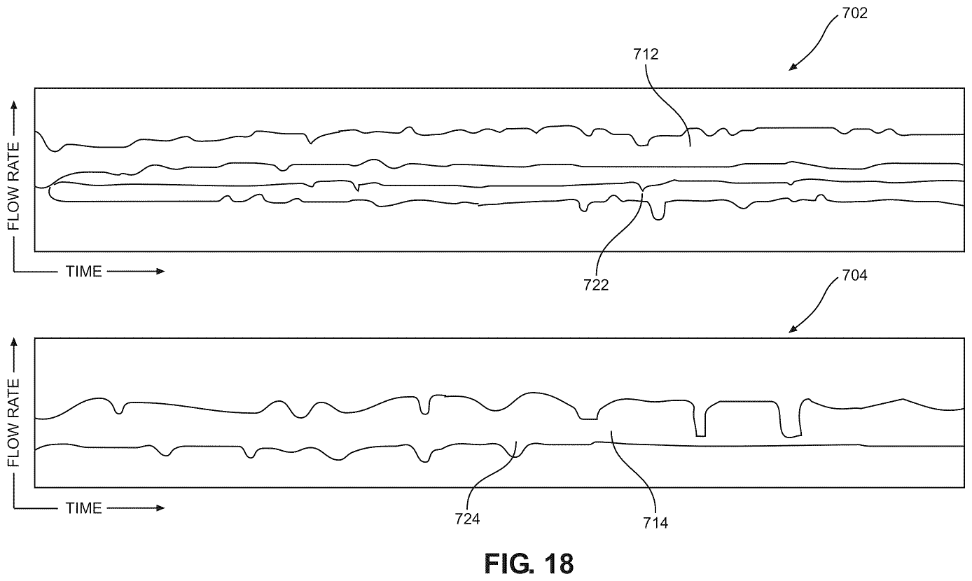

FIG. 18 illustrates a graph of an actual flow rate and measured flow rate versus time for implementation without the flow conditioning device according to aspects of the disclosure; and FIG. 18 further illustrates a graph of an actual flow rate and a measured flow rate versus time for implementation with the flow conditioning device according to aspects of the disclosure.

In particular, FIG. 18 illustrates a graph 702 of an actual flow rate 722 and measured flow rate 712 versus time for implementation without the flow conditioning device 100 according to aspects of the disclosure; and FIG. 18 illustrates a graph 704 of an actual flow rate 724 and measured flow rate 714 versus time for implementation with the flow conditioning device 100 according to aspects of the disclosure.

In this regard, it can be seen that in the graph 702 that the actual flow rate 722 and the measured flow rate 712 without the flow conditioning device 100 are dramatically different. On the other hand, as can be seen by the graph 704, the actual flow rate 724 and the measured flow rate 714 implemented with the flow conditioning device 100 according to aspects of the disclosure provides very accurate determination of the flow rate of the dispensing material 208 within the dispensing system 200.

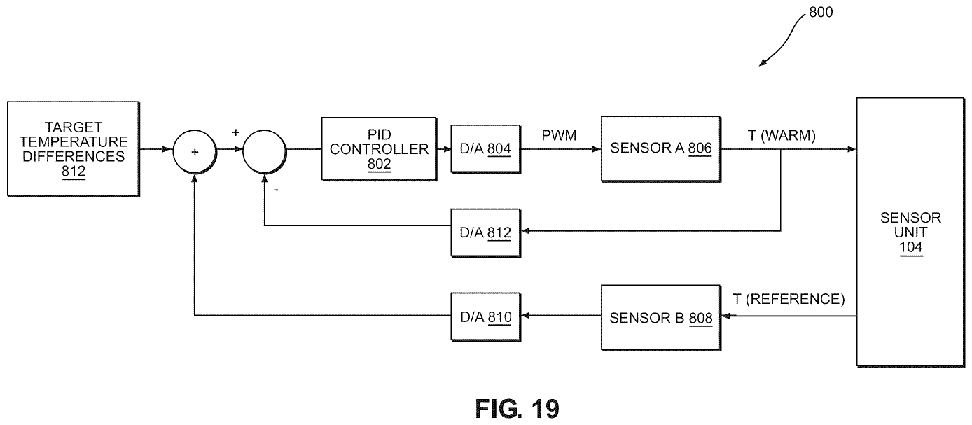

FIG. 19 illustrates an exemplary controller according to aspects of the disclosure.

In particular, FIG. 19 illustrates a controller 800 for the dispensing system 200 that is responsive to the sensor unit 104. In particular, the controller 800 may include a PID controller 802 that outputs a signal to a digital to analog device (D/A 804) to output a pulse width modulated signal to sensor A 806 of the sensor unit 104.

Aspects illustrated in FIG. 19 may be implemented in any other aspect of the disclosure. Moreover, aspects illustrated in FIG. 19 may include any other aspects as disclosed herein.

Additionally, the sensor unit 104 may provide a heated temperature to an analog-to-digital device (D/A 812) of the controller 800. Further, the sensor unit 104 may provide a reference temperature to a sensor B 808. The reference temperature may be provided to an analog-to-digital device (D/A 810) of the controller 800. The output of the D/A 810 may be combined with target temperature differences 812. The combined output may be combined with the output of the D/A 812 and input to the PID controller 802.

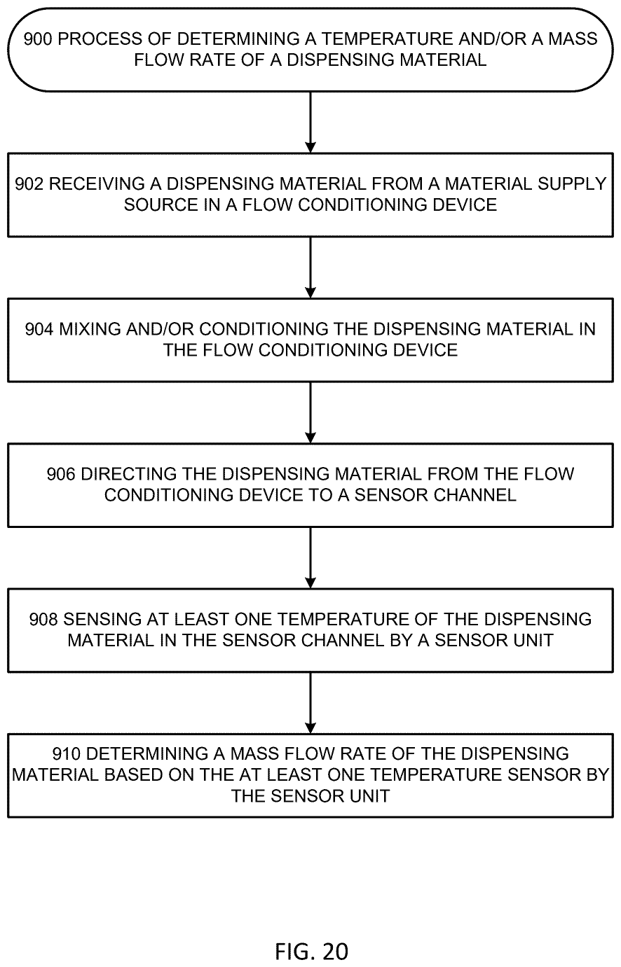

FIG. 20 illustrates a process of determining a temperature and/or a mass flow rate of a dispensing material according to aspects of the disclosure.

In particular, FIG. 20 illustrates a process of determining a temperature and/or a mass flow rate of a dispensing material 900. In this regard, the determining a temperature and/or a mass flow rate of a dispensing material 900 relates to determining a temperature and/or a mass flow rate of the dispensing material 208 as described herein. In particular, it should be noted that the determining a temperature and/or a mass flow rate of a dispensing material 900 is merely exemplary and may be modified consistent with the various aspects disclosed herein. It should be noted that the determining a temperature and/or a mass flow rate of a dispensing material 900 may be performed in a different order consistent with the aspects described above. Moreover, the determining a temperature and/or a mass flow rate of a dispensing material 900 may be modified to have more or fewer process steps consistent with the various aspects disclosed herein. Further, the determining a temperature and/or a mass flow rate of a dispensing material 900 may be implemented in any aspect of the 200 and/or the 800 as described herein.

The determining a temperature and/or a mass flow rate of a dispensing material 900 of the disclosure may include receiving a dispensing material from a material supply source in a flow conditioning device 902. In this regard, the receiving a dispensing material from a material supply source in a flow conditioning device 902 may include any one or more materials, structures, arrangements, processes, and/or the like as described herein. Moreover, one or more proceeding or subsequent processes may also be implemented with respect to the receiving a dispensing material from a material supply source in a flow conditioning device 902 consistent with the disclosure. In particular aspects, the receiving a dispensing material from a material supply source in a flow conditioning device 902 may include receiving the dispensing material 208 from the material supply source 202 in the flow conditioning device 100 as described herein.

The determining a temperature and/or a mass flow rate of a dispensing material 900 of the disclosure may include mixing and/or conditioning the dispensing material in the flow conditioning device 904. In this regard, the mixing and/or conditioning the dispensing material in the flow conditioning device 904 may include any one or more materials, structures, arrangements, processes, and/or the like as described herein. Moreover, one or more proceeding or subsequent processes may also be implemented with respect to the mixing and/or conditioning the dispensing material in the flow conditioning device 904 consistent with the disclosure. In particular aspects, the mixing and/or conditioning the dispensing material in the flow conditioning device 904 may include mixing and/or conditioning the dispensing material 208 in the flow conditioning device 100 as described herein.

The determining a temperature and/or a mass flow rate of a dispensing material 900 of the disclosure may include directing the dispensing material from the flow conditioning device to a sensor channel 906. In this regard, the directing the dispensing material from the flow conditioning device to a sensor channel 906 may include any one or more materials, structures, arrangements, processes, and/or the like as described herein. Moreover, one or more proceeding or subsequent processes may also be implemented with respect to the directing the dispensing material from the flow conditioning device to a sensor channel 906 consistent with the disclosure. In particular aspects, the directing the dispensing material from the flow conditioning device to a sensor channel 906 may include directing the dispensing material 208 from the flow conditioning device 100 to the sensor channel 120 as described herein.

The determining a temperature and/or a mass flow rate of a dispensing material 900 of the disclosure may include sensing at least one temperature of the dispensing material in the sensor channel by a sensor unit 908. In this regard, the sensing at least one temperature of the dispensing material in the sensor channel by a sensor unit 908 may include any one or more materials, structures, arrangements, processes, and/or the like as described herein. Moreover, one or more proceeding or subsequent processes may also be implemented with respect to the sensing at least one temperature of the dispensing material in the sensor channel by a sensor unit 908 consistent with the disclosure. In particular aspects, the sensing at least one temperature of the dispensing material in the sensor channel by a sensor unit 908 may include sensing at least one temperature of the dispensing material 208 in the sensor channel 120 by the sensor unit 104 as described herein.

The determining a temperature and/or a mass flow rate of a dispensing material 900 of the disclosure may include determining a mass flow rate of the dispensing material based on the at least one temperature sensor by the sensor unit 910. In this regard, the determining a mass flow rate of the dispensing material based on the at least one temperature sensor by the sensor unit 910 may include any one or more materials, structures, arrangements, processes, and/or the like as described herein. Moreover, one or more proceeding or subsequent processes may also be implemented with respect to the determining a mass flow rate of the dispensing material based on the at least one temperature sensor by the sensor unit 910 consistent with the disclosure. In particular aspects, the determining a mass flow rate of the dispensing material based on the at least one temperature sensor by the sensor unit 910 may include determining a mass flow rate of the dispensing material 208 based on the at least one temperature sensor by the sensor unit 104 as described herein.

Accordingly, the disclosure as set forth a device and process for reducing variations in the temperature of the flowable material in proximity to a sensor unit to increase flow data accuracy.

The following are a number of nonlimiting EXAMPLES of aspects of the disclosure.

One EXAMPLE includes: a sensing device that includes a flow conditioning device configured to receive a dispensing material and the flow conditioning device is further configured mix the dispensing material and equalize a thermal profile of the dispensing material. The sensing device in addition includes a sensor channel configured to receive the dispensing material from the flow conditioning device. The sensing device moreover includes a sensor unit configured to measure a temperature of the dispensing material in the sensor channel.

The above-noted EXAMPLE may further include any one or a combination of more than one of the following EXAMPLES: The sensing device of the above-noted EXAMPLE where the flow conditioning device is configured to mix the dispensing material such that the sensor unit generates a more accurate temperature measurement, temperature sensing, and/or mass flow determination. The sensing device of the above-noted EXAMPLE where the flow conditioning device is configured to mix the dispensing material as the dispensing material is in the flow conditioning device. The sensing device of the above-noted EXAMPLE where the flow conditioning device is configured to provide a more homogeneous laminar flow of the dispensing material. The sensing device of the above-noted EXAMPLE where the flow conditioning device is configured to mix, generate swirl, and/or generate turbulence in the dispensing material as the dispensing material is in the flow conditioning device. The sensing device of the above-noted EXAMPLE where the flow conditioning device may include mixing elements configured to mix a flow of the dispensing material. The sensing device of the above-noted EXAMPLE where the sensor unit may include a convection anemometry mass flow sensor. The sensing device of the above-noted EXAMPLE where the flow conditioning device is configured to provide a more homogenous laminar flow of the dispensing material in the sensor channel. The sensing device of the above-noted EXAMPLE where the flow conditioning device is configured to provide the sensor unit a more accurate measurement of a temperature and/or a flow rate of the dispensing material. The sensing device of the above-noted EXAMPLE where the flow conditioning device is arranged upstream of and in proximity to the sensor channel and the sensor unit. The sensing device of the above-noted EXAMPLE where the flow conditioning device is arranged upstream a distance from a center of the sensor unit; where the sensor channel may include a dimension; and where the distance is less than the dimension. The sensing device of the above-noted EXAMPLE where the flow conditioning device is arranged upstream a distance from a center of the sensor unit; where the sensor channel may include a dimension; and where the distance is 1 20 times greater than the dimension. The sensing device of the above-noted EXAMPLE where the flow conditioning device is implemented in a static mixer adapter unit; and where the static mixer adapter unit is arranged between a dispensing device and a material transport device. The sensing device of the above-noted EXAMPLE where the material transport device is an adhesive transport hose. The sensing device of the above-noted EXAMPLE where the sensor unit and the sensor channel are arranged in the dispensing device. The sensing device of the above-noted EXAMPLE where the static mixer adapter unit may include a housing configured to house the flow conditioning device; and where the housing may include a heating device. The sensing device of the above-noted EXAMPLE where the static mixer adapter unit may include at least one connector configured to connect the static mixer adapter unit to the material transport device. The sensing device of the above-noted EXAMPLE where the static mixer adapter unit may include at least one connector configured to connect the static mixer adapter unit to the dispensing device. The sensing device of the above-noted EXAMPLE where the flow conditioning device is implemented in a hose adapter unit; and where the hose adapter unit may include the sensor channel and the sensor unit.

The sensing device of the above-noted EXAMPLE where the hose adapter unit is arranged between a dispensing device and a material transport device. The sensing device of the above-noted EXAMPLE where the hose adapter unit may include at least one connector configured to connect the hose adapter unit to a material transport device. The sensing device of the above-noted EXAMPLE where the hose adapter unit may include at least one connector configured to connect the hose adapter unit to a dispensing device. The sensing device of the above-noted EXAMPLE where the flow conditioning device is implemented in a material transport device. The sensing device of the above-noted EXAMPLE where the material transport device may include an adhesive transport hose. The sensing device of the above-noted EXAMPLE where the material transport device may include a heating device configured to heat the material transport device, the dispensing material flowing through the material transport device, and/or the flow conditioning device. The sensing device of the above-noted EXAMPLE where the material transport device may include a connector that is configured to connect the material transport device to a dispensing device. The sensing device of the above-noted EXAMPLE where the flow conditioning device is configured to extend into the connector. The dispensing system of the above-noted EXAMPLE and the dispensing system may include: a material supply source, a dispensing device, and a material transport device. The dispensing system of the above-noted EXAMPLE where the dispensing system may include an adhesive dispensing system; where the dispensing device is an adhesive dispenser; and where the material transport device is an adhesive transport hose. The dispensing system of the above-noted EXAMPLE where the dispensing system may include a hotmelt adhesive dispensing system; where the dispensing device is a hotmelt adhesive dispenser; and where the material transport device is a hotmelt adhesive transport hose.

One EXAMPLE includes: a process that includes configuring a flow conditioning device to receive a dispensing material. The process in addition includes mixing the dispensing material and equalizing a thermal profile of the dispensing material with the flow conditioning device. The process moreover includes receiving the dispensing material from the flow conditioning device in a sensor channel. The process also includes measuring a temperature of the dispensing material in the sensor channel with a sensor unit.

The above-noted EXAMPLE may further include any one or a combination of more than one of the following EXAMPLES: The process of the above-noted EXAMPLE where the flow conditioning device is configured to mix the dispensing material such that the sensor unit generates a more accurate temperature measurement, temperature sensing, and/or mass flow determination. The process of the above-noted EXAMPLE where the flow conditioning device is configured to mix the dispensing material as the dispensing material is in the flow conditioning device. The process of the above-noted EXAMPLE where the flow conditioning device is configured to provide a more homogeneous laminar flow of the dispensing material. The process of the above-noted EXAMPLE where the flow conditioning device is configured to mix, generate swirl, and/or generate turbulence in the dispensing material as the dispensing material is in the flow conditioning device. The process of the above-noted EXAMPLE where the flow conditioning device may include mixing elements configured to mix a flow of the dispensing material. The process of the above-noted EXAMPLE where the sensor unit may include a convection anemometry mass flow sensor. The process of the above-noted EXAMPLE where the flow conditioning device is configured to provide a more homogenous laminar flow of the dispensing material in the sensor channel. The process of the above-noted EXAMPLE where the flow conditioning device is configured to provide the sensor unit a more accurate measurement of a temperature and/or a flow rate of the dispensing material. The process of the above-noted EXAMPLE where the flow conditioning device is arranged upstream of and in proximity to the sensor channel and the sensor unit. The process of the above-noted EXAMPLE where the flow conditioning device is arranged upstream a distance from a center of the sensor unit; where the sensor channel may include a dimension; and where the distance is less than the dimension. The process of the above-noted EXAMPLE where the flow conditioning device is arranged upstream a distance from a center of the sensor unit; where the sensor channel may include a dimension; and where the distance is 1 20 times greater than the dimension. The process of the above-noted EXAMPLE where the flow conditioning device is implemented in a static mixer adapter unit; and where the static mixer adapter unit is arranged between a dispensing device and a material transport device. The process of the above-noted EXAMPLE where the material transport device is an adhesive transport hose. The process of the above-noted EXAMPLE where the sensor unit and the sensor channel are arranged in the dispensing device. The process of the above-noted EXAMPLE where the static mixer adapter unit may include a housing configured to house the flow conditioning device; and where the housing may include a heating device. The process of the above-noted EXAMPLE where the static mixer adapter unit may include at least one connector configured to connect the static mixer adapter unit to the material transport device. The process of the above-noted EXAMPLE where the static mixer adapter unit may include at least one connector configured to connect the static mixer adapter unit to the dispensing device. The process of the above-noted EXAMPLE where the flow conditioning device is implemented in a hose adapter unit; and where the hose adapter unit may include the sensor channel and the sensor unit. The process of the above-noted EXAMPLE where the hose adapter unit is arranged between a dispensing device and a material transport device. The process of the above-noted EXAMPLE where the hose adapter unit may include at least one connector configured to connect the hose adapter unit to a material transport device. The process of the above-noted EXAMPLE where the hose adapter unit may include at least one connector configured to connect the hose adapter unit to a dispensing device. The process of the above-noted EXAMPLE where the flow conditioning device is implemented in a material transport device. The process of the above-noted EXAMPLE where the material transport device may include an adhesive transport hose. The process of the above-noted EXAMPLE where the material transport device may include a heating device configured to heat the material transport device, the dispensing material flowing through the material transport device, and/or the flow conditioning device. The process of the above-noted EXAMPLE where the material transport device may include a connector that is configured to connect the material transport device to a dispensing device. The process of the above-noted EXAMPLE where the flow conditioning device is configured to extend into the connector. The process of the above-noted EXAMPLE may include implementing the sensing device and a dispensing system that may include a material supply source, a dispensing device, and a material transport device. The process of the above-noted EXAMPLE where the dispensing system may include an adhesive dispensing system; where the dispensing device is an adhesive dispenser; and where the material transport device is an adhesive transport hose. The process of the above-noted EXAMPLE where the dispensing system may include a hotmelt adhesive dispensing system; where the dispensing device is a hotmelt adhesive dispenser; and where the material transport device is a hotmelt adhesive transport hose.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto another element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over another element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to another element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

The many features and advantages of the disclosure are apparent from the detailed specification, and, thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

1. A sensing device comprising:
a flow conditioning device configured to receive a dispensing material and the flow conditioning device is further configured mix the dispensing material and equalize a thermal profile of the dispensing material;
a sensor channel configured to receive the dispensing material from the flow conditioning device; and
a sensor unit configured to measure a temperature of the dispensing material in the sensor channel.

2. (canceled)

3. The sensing device according to claim 1 wherein the flow conditioning device is configured to mix the dispensing material as the dispensing material is in the flow conditioning device.

4. (canceled)

5. The sensing device according to claim 1 wherein the flow conditioning device is configured to mix, generate swirl, and/or generate turbulence in the dispensing material as the dispensing material is in the flow conditioning device.

6. The sensing device according to claim 1 wherein the flow conditioning device comprises mixing elements configured to mix a flow of the dispensing material.

7. The sensing device according to claim 1 wherein the sensor unit comprises a convection anemometry mass flow sensor.

8. The sensing device according to claim 1 wherein the flow conditioning device is configured to provide a more homogenous laminar flow of the dispensing material in the sensor channel.

9. (canceled)

10. The sensing device according to claim 1 wherein the flow conditioning device is arranged upstream of and in proximity to the sensor channel and the sensor unit.

11. The sensing device according to claim 1
wherein the flow conditioning device is arranged upstream a distance from a center of the sensor unit;
wherein the sensor channel comprises a dimension; and
wherein the distance is less than the dimension.

12. The sensing device according to claim 1
wherein the flow conditioning device is arranged upstream a distance from a center of the sensor unit;
wherein the sensor channel comprises a dimension; and
wherein the distance is 1-20 times greater than the dimension.

13. The sensing device according to claim 1 wherein the flow conditioning device is implemented in a static mixer adapter unit; and
wherein the static mixer adapter unit is arranged between a dispensing device and a material transport device.

14.-18. (canceled)

19. The sensing device according to claim 1
wherein the flow conditioning device is implemented in a hose adapter unit; and
wherein the hose adapter unit comprises the sensor channel and the sensor unit.

20.-22. (canceled)

23. The sensing device according to claim 1 wherein the flow conditioning device is implemented in a material transport device.

24.-27. (canceled)

28. The sensing device according to claim 1 wherein the flow conditioning device is arranged in a flow channel of a dispensing device.

29. The sensing device according to claim 28 wherein the sensor unit and the sensor channel are arranged in the dispensing device.

30. The sensing device according to claim 1 wherein the flow conditioning device is arranged in an applicator manifold of a dispensing device.

31. The sensing device according to claim 30 wherein the sensor unit and the sensor channel are arranged in the dispensing device.

32. The sensing device according to claim 1 wherein the sensor unit and the sensor channel are arranged in a dispensing device.

33. (canceled)

34. A dispensing system comprising the sensing device according to claim 1, and the dispensing system further comprising:
a material supply source, a dispensing device, and a material transport device.

35. The dispensing system according to claim 34
wherein the dispensing system comprises an adhesive dispensing system;
wherein the dispensing device is an adhesive dispenser; and
wherein the material transport device is an adhesive transport hose.

36. (canceled)

37. A process of implementing a sensing device comprising:
configuring a flow conditioning device to receive a dispensing material;
mixing the dispensing material and equalizing a thermal profile of the dispensing material with the flow conditioning device;
receiving the dispensing material from the flow conditioning device in a sensor channel; and
measuring a temperature of the dispensing material in the sensor channel with a sensor unit.

38.-72. (canceled)
